(19) United States
(12) Patent Application Publication
(10) Pub. No.: US 2017/0282949 A1
(43) Pub. Date: Oct. 5, 2017

(54) COMPONENT CART ASSEMBLY

(71) Applicant: Fives Cinetic Corp., Farmington Hills, MI (US)

(72) Inventors: Gilberto Gonzalez, Saltillo (MX); Nestor Reyna, Saltillo (MX)

(73) Assignee: Fives Cinetic Corp., Farmington Hills, MI (US)

(21) Appl. No.: 15/471,499

(22) Filed: Mar. 28, 2017

Related U.S. Application Data
(60) Provisional application No. 62/314,487, filed on Mar. 29, 2016.

(51) Int. Cl. B62B 3/02; B62B 3/00

(52) U.S. Cl. CPC B62B 3/02; B62B 3/005; B62B 3/003; B62B 3/004; B62B 5/061

(57) ABSTRACT

A cart assembly includes a base with wheels, a shelf support structure orthogonally arranged with respect to the base, one or more shelves supported by the support structure, and a swivel mechanism. The swivel mechanism is coupled to the base and the shelf support structure to provide an axis of rotation, such that the shelf support structure and the shelf or shelves are selectively rotatable with respect to the axis. The swivel mechanism may include a race that defines a socket on a circumference of the race. A pin is selectively engageable with the socket to prevent rotation of the race and the support structure. The shelf may include a thermoformed plastic tray, or three shelves arranged at three different levels of the shelf support structure. Some of the shelves may fold against and secure to the shelf support structure.

### CROSS-REFERENCE TO RELATED APPLICATIONS

This application claims the benefit of U.S. Provisional Patent Application Ser. No. 62/314,487, filed on Mar. 29, 2016, the disclosure of which is hereby incorporated by reference.

### TECHNICAL FIELD

The disclosure relates to a component cart assembly.

### BACKGROUND

Manufacturing involves the combined use of labor, machines, process equipment, and tools to produce finished goods. In a typical manufacturing plant environment, parts or other components are transported via a component cart to an assembly line or a work cell. The components are then staged in a manner that is accessible to an operator performing the manufacturing process steps. However, component carts of the type typically used to facilitate in-plant transport and staging of components may be less than optimal, particularly in terms of ease of ergonomic positioning.

### SUMMARY

A cart assembly for use in a manufacturing process is disclosed herein. The cart assembly enables parts, assemblies, or other components to be arranged on one or more levels on trays or shelves and presented to an operator in an ergonomically friendly manner relative to prior art cart assemblies. The present cart assembly in its various embodiments includes a center swivel mechanism that is selectively unlocked to allow rotation of upper portions of the cart assembly relative to a base, and to thereby facilitate access to staged components from any side of the cart assembly. In some embodiments, when a given shelf is not in use, the shelf may be folded against and secured to an upright member of the cart assembly for stowing, and to provide ready access to a vertically adjacent shelf.

In a particular embodiment, the cart assembly includes a base with wheels, a shelf support structure, at least one shelf, and the swivel mechanism noted above. The shelf support structure is orthogonally arranged with respect to the base, i.e., includes longitudinal members arranged 90 degrees to the base. Each shelf is supported by the support structure. The swivel mechanism, which is coupled to the base and the shelf support structure, provides the cart assembly with an axis of rotation, such that the shelf support structure is selectively unlocked from the base and rotated about the axis of rotation.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a first embodiment of a component cart assembly.

FIG. 2 is a partially cut-away schematic perspective view of a swivel mechanism of the component cart assembly.

FIG. 3 is a schematic perspective view of a second embodiment of the component cart assembly.

FIG. 4 is a schematic perspective view of the second embodiment of the component cart assembly showing shelves in a folded and latched position.

FIG. 5 is a schematic side view of the second embodiment of the component cart assembly showing shelves in the folded and latched positions.

FIG. 6 is a schematic perspective view of the second embodiment of the component cart assembly showing optional counterweights arranged on some of the shelves.

FIG. 7 is a schematic perspective view of the second embodiment of the component cart assembly showing optional walls and doors enclosing the shelves.

FIG. 8 is a schematic perspective view of the second embodiment of the component cart assembly showing an elongated opening in a door.

FIG. 9 is a schematic perspective view of the second embodiment of the cart assembly showing an optional bar and other structural elements for retaining components on the component cart assembly.

FIG. 10 is a schematic perspective view of pair of transport mechanisms for interfacing with a pair of the component cart assemblies.

FIG. 11 is a schematic perspective cross sectional view of the swivel mechanism.

FIG. 12 is a schematic fragmentary plan view of the cart assembly showing a pin actuator system.

### DETAILED DESCRIPTION

Referring to the drawings, wherein like numerals indicate like parts throughout the several views, a component cart assembly 100 is disclosed herein. The cart assembly 100 is shown with respect to an exemplary XYZ coordinate system, with a Z axis indicating a vertical/height direction with respect to a level of a floor 10, and an X axis and a Y axis representing the width and length dimensions of a plane disposed generally parallel with the floor 10. Therefore, the characters X, Y, and Z, when appended to a reference number herein, indicate the axial orientation of a particular structural element of the cart assembly 100.

The component cart assembly 100 is operable for cleanly and efficiently transporting and staging manufacturing components 102 within a manufacturing process facility. The components 102 may be embodied as any part, piece, or assembly depending on the particular manufacturing process, e.g., flywheels as shown, or covers, pans, pumps, or other components 102 in various example applications.

The cart assembly 100 in all embodiments includes a base 104 having elongated frame members 106X and 106Y arranged parallel to the floor 10. The frame members 106X and 106Y may be referred and/or shown generically by the reference numeral 106. The frame members 106X, 106Y may be constructed of tubular material such as aluminum, carbon steel, stainless steel, iron, or alloys thereof, and may have a rectangular cross-section as shown or any other desired cross-sectional shape. Alternatively, the frame members 106X, 106Y may be formed from other process-suitable materials, including but not limited to plastic, fiberglass, and/or composite materials.

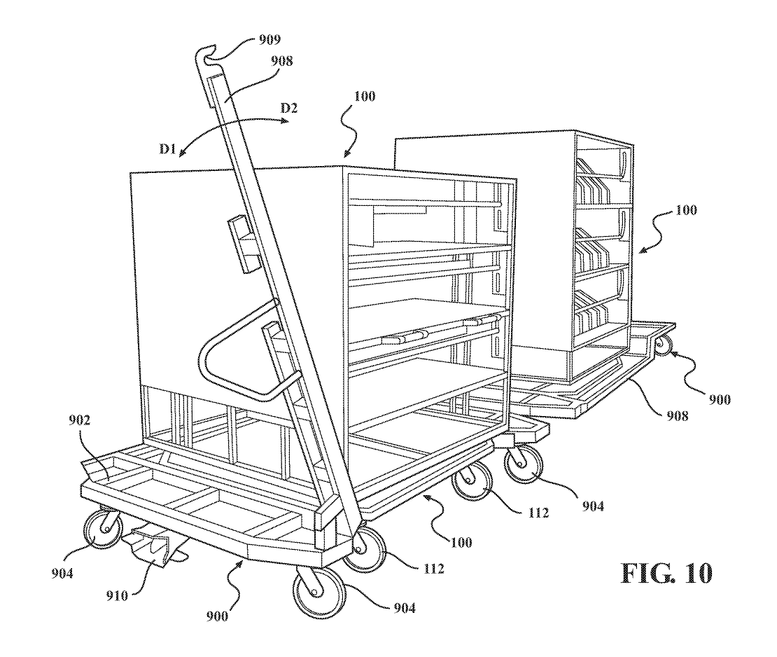

The frame members 106X and 106Y may be connected together such as via welding, bonding, and/or fastening to provide the base 104 with a generally rectangular periphery 107, with optional chamfered corners 108 used to facilitate transport of the cart assembly 100 as described below with reference to FIG. 10. The base 104 may also include various reinforcing plates 110 coupled to the frame members 106X, 106Y, and may also include additional cross members as needed to provide the requisite structural integrity.

The cart assembly 100 may also include wheels 112, for instance four wheels 112 disposed at the four corners of the cart assembly 100 as shown. Each wheel 112 is operatively connected to the base 104 and configured to support the base 104, as well as to allow free rolling movement of the cart assembly 110 with respect to the floor 10 when the cart assembly 110 is moved through a manufacturing facility. The wheels 112 may be embodied as casters that swivel and/or rotate or any other suitable type of wheel, as will be readily appreciated by those of ordinary skill in the art.

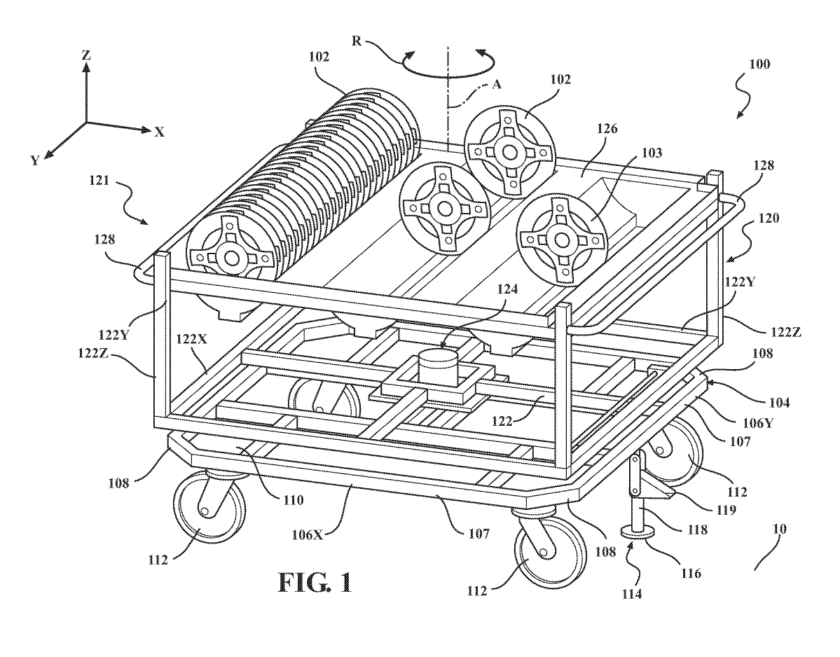

Additionally, the cart assembly 100 may include a brake 114, for instance as shown schematically at the bottom right corner of FIG. 1. The brake 114 is configured to prevent undesired rolling movement of the cart assembly 100 once the cart assembly 100 has been positioned with respect to a given work cell or assembly line. In an optional configuration, the brake 114, which may be securely coupled to the base 104 at an approximate midpoint of the periphery 107, may include a flat disc 116 that rests on the floor 10. The disc 116 in the example embodiment of FIG. 1 is coupled to a short length of vertical rod 118, with the vertical rod 118 being rotatable or otherwise movable with respect to a compression mechanism 119, e.g., a ratchet arm, to force the disc 116 downward into firm engagement with the floor 10. Other embodiments of the brake 114 may be envisioned within the intended inventive scope, such as individual locking mechanisms on one or more of the wheels 112.

The cart assembly 100 also includes a shelf support structure 120 that is orthogonally arranged with respect to the base 104, i.e., extending vertically in the Z direction with respect to the XY planar orientation of the base 104 and the floor 10. The shelf support structure 120 includes additional frame members 122X, 122Y, and 122Z having a generally rectangular or square cross-section as shown. The additional frame members 122X, 122Y, and 122Z, as with the frame members 106X, 106Y, of the base 104 as described above, may be formed of metal, plastic, fiberglass, and/or composite materials, whether tubular or solid in construction.

In the representative embodiment shown in FIG. 1, the cart assembly 100 of FIG. 1 also includes at least one shelf in the form of a tray 126 that supports one or more of the components 102. The tray 126 may be formed primarily of plastic or other suitable lightweight materials. In an example embodiment, the tray 126 may be thermoformed plastic having a contoured surface 103 matching a contour of the components 102, and therefore suitable for cradling and supporting a plurality of the components 102. A handlebar 128 may be fastened to each of a pair of ends 121 of the cart assembly 100 to aid in movement of the cart assembly 100 and/or in rotation of the shelf support structure 120, as described in greater detail below.

To facilitate rotation of the cart assembly 100 about an axis A, as indicated by double-headed arrow R, the component cart assembly 100 may also include a swivel mechanism 124. Use of the swivel mechanism 124 allows for convenient access to the components 102 shown in FIG. 1. A user of the cart assembly 100 can easily rotate the shelf support structure 120 via the swivel mechanism 124 to bring some of the components 102 closer to a load station (not shown), for example, without having to move or otherwise maneuver the entire cart assembly 100.

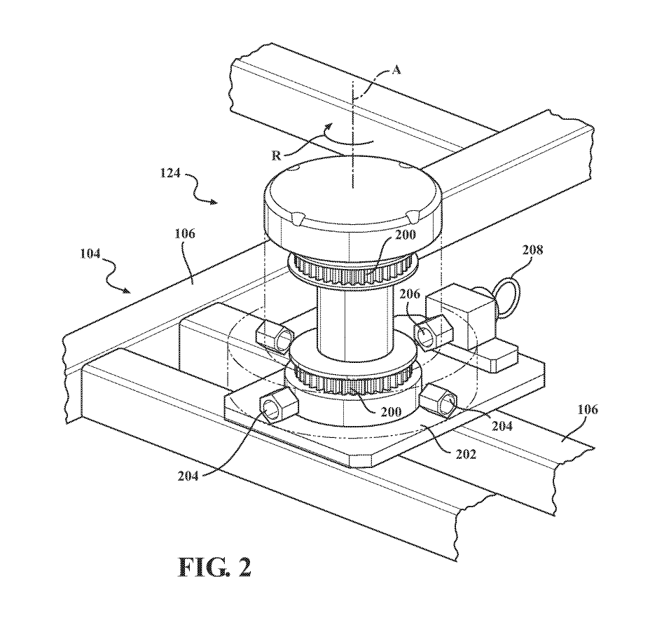

Such a swivel mechanism 124 shown in FIG. 2 is supported by the base 104 and rotatably couples the shelf support structure 120 of FIG. 1 to the base 104 to provide an axis of rotation A as shown in FIG. 2. Such rotatable coupling allows the shelf support structure 120 to freely rotate about the axis of rotation A with respect to the base 104 and vice-versa, thereby allowing an operator to access the tray 126 of FIG. 1 from either side of the cart assembly 100.

The swivel mechanism 124 is disposed at or near a center of the base 104. The swivel mechanism 124 may include bearings 200 to facilitate such rotation, as well as a race 202. The race 202 may define at least one socket 204 that rotates about the axis of rotation A in conjunction with the race 202. The race 202 may optionally define four such sockets 204 as shown, with each socket 204 equidistant from two other such sockets 204. That is, the sockets 204 are disposed at 0°, 90°, 180°, and 270° around a circumference of the race 202. While four sockets 204 are shown in FIG. 2, any number of sockets 204 may be implemented.

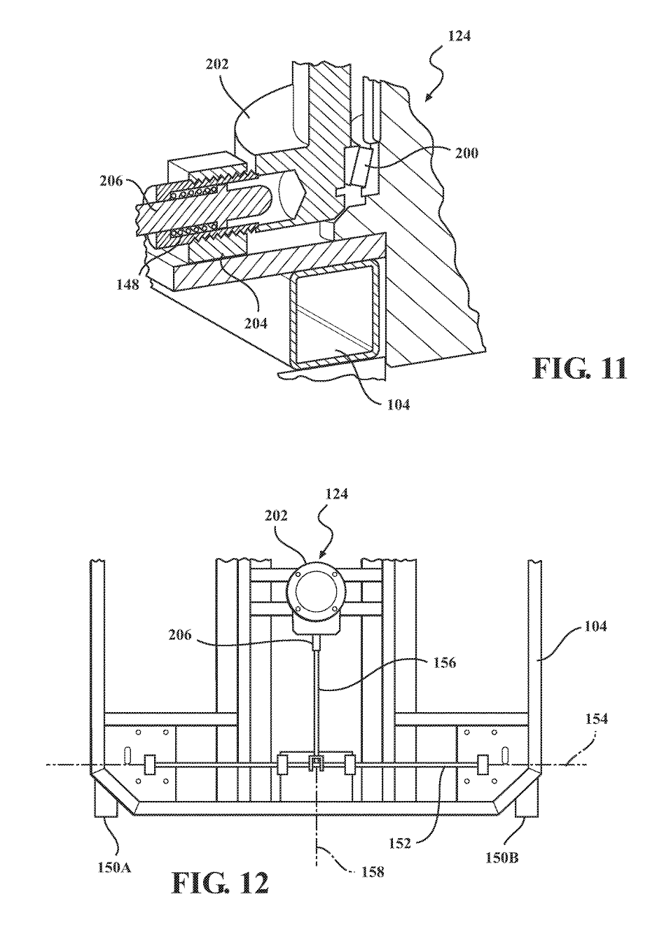

The swivel mechanism 124 in the embodiment having the sockets 204 also includes at least one retractable pin 206 that is engaged with a respective one of the sockets 204 and coupled to the base structure 104. As such, when the pin 206 is engaged with one of the sockets 204, the race 202 is firmly locked in place and the support structure 120 cannot rotate. A pin handle 208 may be coupled to the pin 206 so as to facilitate movement of the pin 206. That is, the pin handle 208 may be actuated to unlatch the pin 206 from the socket 204 and thereby allow free rotation of the tray support structure 120. As is known in the art, a spring (shown in FIG. 12 at 148) may be utilized to bias the pin 206 toward one of the sockets 204. While the handle 208 shown in FIG. 2 is disposed near the swivel mechanism 124, that the handle 208 may be disposed near the periphery 107 of the base 104 to more easily allow actuation by a user of the cart assembly 100.

Referring to FIG. 11, the swivel mechanism 124 is shown in greater detail. As shown in FIG. 11, the retractable pin 206 is selectively operable to engage one of the sockets 204. The spring 148 biases the retractable pin 206 into and/or toward the race, and into engagement with one of the plurality of sockets 204. When the retractable pin 206 is positioned within one of the sockets 204, the race 202 and the shelf support structure 120 cannot rotate relative to the base 104. However, when the retractable pin 206 is disengaged from the sockets 204, such as shown in FIG. 11, then the race 202 and the shelf support structure 120 are free to rotate about the axis R to position the shelves 126 relative to the base 104.

Referring to FIG. 12, an optional pin actuator system for adjusting a position of the cart assembly 100 described above via pedals positioned at two of the corners of the cart assembly 100 is shown. The pin actuator system includes a first pedal 150A and a second pedal 150B disposed at adjacent corners of the base 104. The first pedal 150A and the second pedal 150B are attached to a pedal shaft 152. The pedal shaft 152 is rotatably attached to the base 104 for rotation about a pedal shaft axis 154. The pedal shaft 152 is attached to a pin shaft 156, which is in turn attached to the retractable pin 206. Pressing either of the first pedal 150A or the second pedal 150B rotates the pedal shaft 152 about the shaft axis 154. The pin shaft 156 is attached to the pedal shaft 152 at a location that is laterally offset from the shaft axis 154 of the pedal shaft 152. Accordingly, rotation of the pedal shaft 152 about the pedal shaft axis 154 causes the pin shaft 156 to move axially along a pin shaft axis 158. Movement of the pin shaft 156 along the pin shaft axis 158 moves the retractable pin 206 out of the engaged position and into the disengaged position. When the first pedal 150A and/or the second pedal 150B are released, the spring 148 biases the retractable pin 206 toward the race 202, and back into one of the sockets 204.

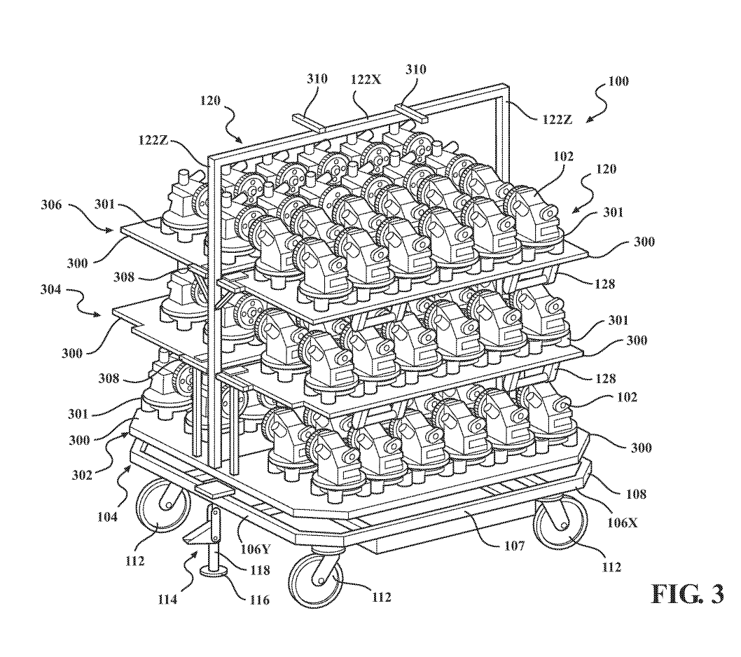

Referring to FIG. 3, the component cart assembly 100 in another embodiment may include a plurality of component shelves 300 each supported from below by the shelf support structure 120 and base 104. In lieu of the tray 126 described above, each shelf 300 may be integrally formed with or support one or more receptacles 301. Each receptacle 301 in turn supports a respective one of the components 102. The receptacles 301 may be custom designed and/or otherwise configured to hold the specific component 102, and thus the configuration of the receptacles 301 is not necessarily as shown in the FIG. 1. The handlebars 128 may be supported by, i.e., coupled to, each of the shelves 300. For instance, two such handlebars 128 may be coupled to each shelf 300 at the second level 304 and the third level 306.

The shelves 300 may be arranged in multiple tiers or otherwise situated at various elevations or levels with respect to a level of the floor 10, e.g., levels 302, 304, and 306. For example, the embodiment shown in FIG. 3 utilizes two such shelves 300 at a first level 302, i.e., a lower level, along with two shelves 300 at a second or intermediate level 304, and two more shelves 300 at a third or upper level 306. As used herein, the terms “lower”, “intermediate”, and “upper” are taken with respect to a standing operator (not shown), and therefore mean that the first level 302 is disposed proximate the base 104 and closest to the floor 10, the second level 304 is disposed above the first level 302, and the third level 306 is disposed above the second level 304.

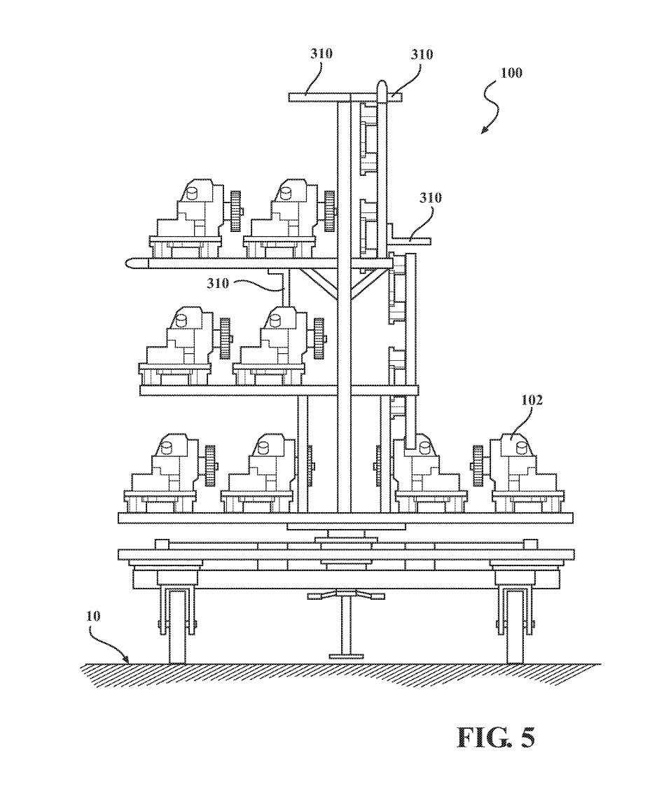

The shelves 300 may be individually folded away and stowed to allow easier access to components 102 on the various levels 302, 304, and 306. As such, a high volume of the components 102 may be supported by the cart assembly 100 while still allowing for convenient, unimpeded access to the components 102, as best shown in FIG. 5, which also provides example dimensions for a three-tier configuration of the cart assembly 100.

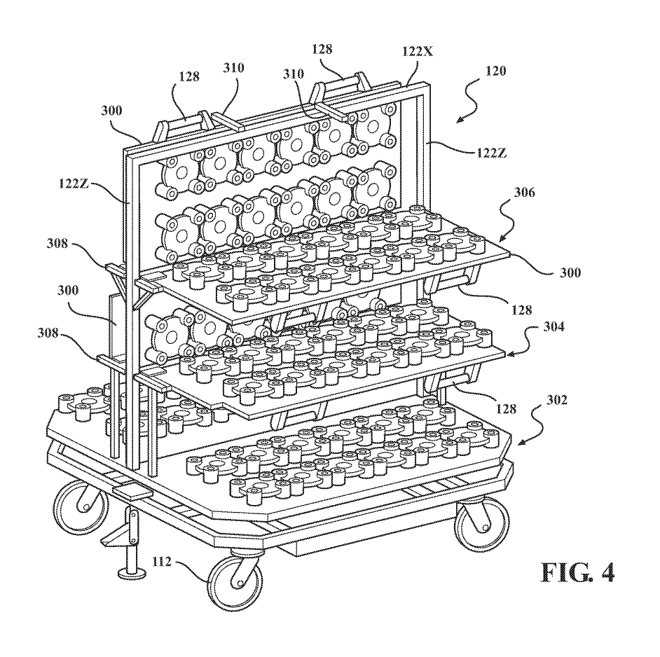

Specifically, in the schematic embodiments shown in FIGS. 3-5, the shelves 300 may be configured to fold against and secure to the shelf support structure 120. In the a position shown in FIG. 3, for instance, the shelves 300 are extended and disposed generally parallel to the plane of the floor 10, i.e., generally arranged in the XY plane. In the second position shown in FIGS. 4 and 5, some of the shelves 300 may be disposed generally perpendicular to the floor 10. The shelves 300 at the respective second and third levels 304 and 306 are rotatable about a hinge rod 308 to move between the first and second positions, or in other words are folded up to facilitate access to the components 120 on a shelf 300 located below the folded or stowed shelf 300.

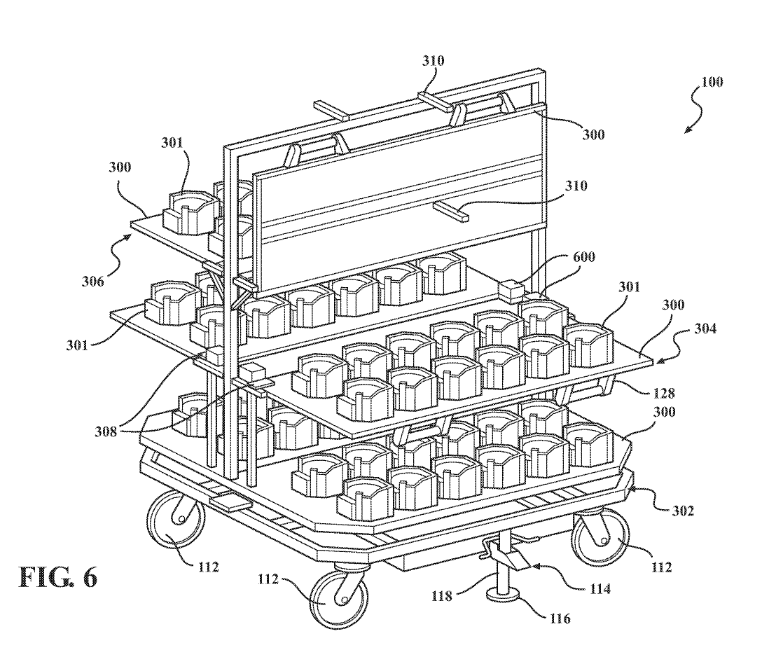

The component cart assembly 100 may also include one or more shelf latching mechanisms 310 as depicted schematically at the top of FIGS. 3-6. Two such shelf latching mechanisms 310 may be coupled to a frame member 122X of the support structure 120, i.e., a cross member spanning the shelves 300 and extending between and connecting two upright or Z-axis oriented frame members 122Z of the frame 122. The shelf latching mechanisms 310 may be orthogonally arranged with respect to the frame member 122X, and may engage with one of the handles 128 to hold the shelves 300 of the third level 306 in the second position. Also in the exemplary embodiments, latching mechanisms 310 are coupled to a bottom (not numbered) of the shelves 300 of the third level 306. The latching mechanisms 310 may engage with one of the handlebars 128 to retain the shelves 300 of the second level 304 in the second position as shown in FIG. 6. Various configurations of the latching mechanisms 310 may be envisioned, e.g., hooks, magnetic couplings, or latches.

In FIG. 6, the cart assembly 100 is shown to include an optional counterweight 600 coupled to one or more of the shelves 300. The counterweights 600 are disposed between the hinge rod 308 and a center of the cart assembly 100. Use of such counterweights 600 may improve adjustability of the shelves 300, specifically by reducing the amount of force required to move the shelves 300 between the first and second positions, as is known in the art. Also visible from the perspective of FIG. 6 is a possible embodiment of the receptacles 301 for components 102 in the form of example water pumps (not shown).

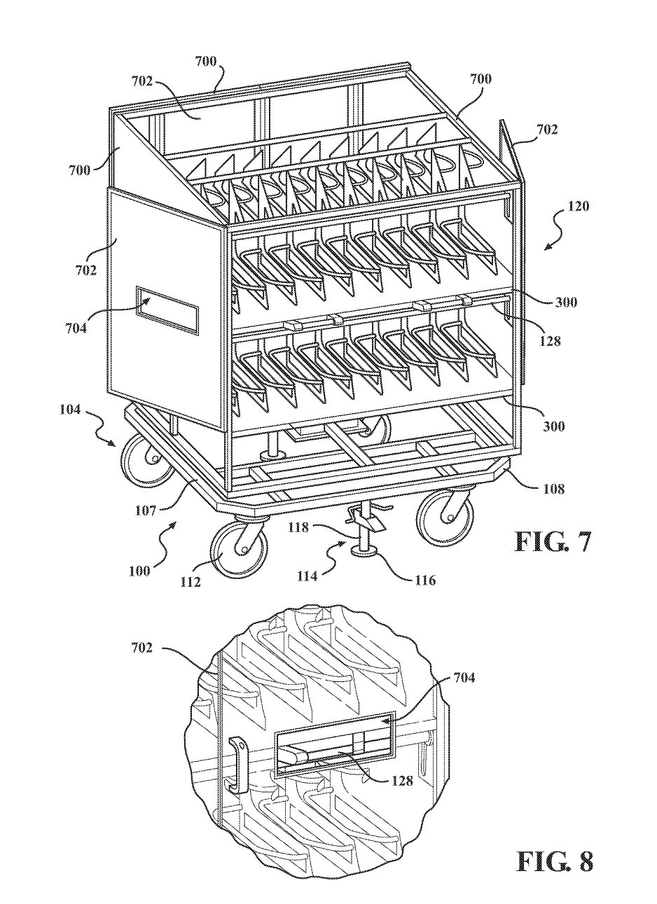

Referring to FIG. 7, the shelf support structure 120 of the component cart assembly 100 may optionally include walls 700 connected to the shelf support structure 120 and constructed of thin lightweight panels of plastic, aluminum, stainless steel, or other suitable clean and sturdy material. The walls 700 surround the shelves 300 and protect any components 102 arranged on the shelves 300 and supported by the support structure 120. At least one handlebar 128 may be coupled to at least one of the shelves 300.

The shelf support structure 120 of the cart assembly 100 may also include one or more doors 702, some or all of which may define an elongated through opening 704 for accessing the handlebars 128. In the exemplary embodiment shown in FIG. 7, the cart assembly 100 includes four such doors 702 providing access to opposite sides of the shelves 300. The doors 702 may be formed of the same material or a different material from that used for the walls 700. By way of example, the doors 702 may be constructed from a plastic material or acrylic. The doors 702 may be opened as needed to permit access to the components, or closed to protect the components. While not shown in FIG. 7 for illustrative simplicity, the doors 702 may be secured via a mechanical or magnetic latch, or by any other suitable structure.

FIG. 8 depicts the elongated opening 704 noted above according to an example embodiment, with the elongated opening having a rectangular shape. The elongated opening 704 may be positioned such that the handlebars 128 on the shelf 300 located at the intermediate level of the component cart assembly 100 may be easily accessed to manually guide the cart assembly 100 while the door 702 remains closed.

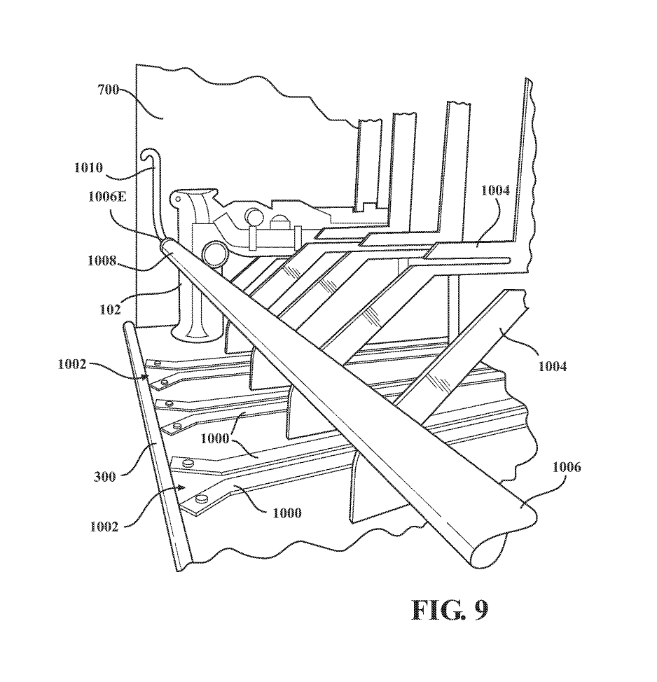

Referring to FIG. 9, an exemplary embodiment of the component cart assembly 100 includes a plurality of guide sections 1000 disposed on a given one of the shelves 300, e.g., molded into the shelves 300 or attached thereto. A respective component (not shown) may be stored between a pair of the guide sections 1000. Each pair of guide sections 1000 may be arranged with respect to each other to form a generally Y-shaped channel 1002, i.e., an elongated linear channel or slot opening into a V near an edge of the shelf 300. The Y-shape channel 1002 allows for easy insertion of a component onto the shelf 300. Vertical dividers 1004 may be disposed between each pair of guide sections 1000 to form permanent or removable walls and thus help maintain lateral separation of adjacent components.

A retaining bar 1006 is movable to hold the components 102 in place during transport, and may be constructed of a hollow metal tube threaded at the ends and covered by urethane or other suitable materials. The bar 1006 also facilitates placement or removal of the components. The bar 1006 may be retained at its distal ends 1006E, only one of which is shown in FIG. 9, by a respective guide plate 1008 coupled to the walls 700, with one such guide plate 1008 visible from the perspective of FIG. 9. Each guide plate 1008 may define a bar channel 1010 that receives a respective distal end 1006E, with each of the bar channels 1010 forming a curved path as shown to help retain the distal ends 1006E. As such, the bar channel 1010 is intended to regulate and guide movement of the bar 1006.

A bottom of the bar channel 1010 angles toward the location of the components (not shown) such that the holding bar 1006 is directed toward such components to ultimately contact or engage the components. The bar channel 1010 may extend upward from the bottom of the bar channel 1010, change direction, and terminate at a top of the bar channel 1010 such that the bar channel 1010 defines a hooked or bent shape. The shape of the bar channel 1010 is sufficient for securing the bar 1006 near a top of the guide plate 1008 to thereby allow unobstructed access to components positioned on the shelves 300.

FIG. 10 depicts an optional transport mechanism 900 that may be utilized to facilitate movement of one or more of the component cart assemblies 100. The transport mechanism 900 includes a base structure 902, wheels 904, a latching bar 908, and a coupling 910. The base structure 902 of the transport mechanism 900 is positioned adjacent to and level with the base structure 104 of the cart assembly 100. The chamfered corners 108 of the cart assembly 100 are intended to facilitate entry of the cart assembly 100 into the recess of the base structure 902.

The latching bar 908 is movable between an open position as shown and a closed/latched position. In a closed position, the latching bar 908 secures the cart assembly 100 to the transport mechanism 900. For example, rotating the latching bar 908 in the direction of arrow D1 to the upright position shown in FIG. 10 may unlock a hooked end 909 of the latching bar 908 from a post or other mating structure of the cart assembly 100. Rotating the latching bar 908 in the direction of arrow D2 produces the opposite result of latching the cart assembly 100 to the base structure 902. While the cart assembly 100 may be used alone in other embodiments, the transport mechanism 900 is intended to enable linking of multiple cart assemblies 100, as well as to facilitate maneuverability of multiple cart assemblies 100 through a plant environment.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A cart assembly as comprising:
a base having a plurality of wheels;
a shelf support structure orthogonally arranged with respect to the base;
at least one shelf supported by the shelf support structure; and
a swivel mechanism rotatably interconnecting the base and the shelf support structure for rotation about an axis of rotation, such that the shelf support structure and the at least one shelf are selectively rotatable with respect to the axis of rotation relative to the base.

2. The cart assembly of claim 1, wherein the swivel mechanism includes a race that rotates with the shelf support structure about the axis of rotation.

3. The cart assembly of claim 2, wherein the race defines at least one socket disposed on a circumference of the race.

4. The cart assembly of claim 3, wherein the at least one socket includes a plurality of sockets positioned about the axis of rotation.

5. The cart assembly of claim 3, wherein the swivel mechanism includes a retractable pin connected to the base, wherein the retractable pin is moveable between an engaged position for interlocking engagement with one of the at least one sockets of the race to prevent rotation of the race and the shelf support structure about the axis of rotation, and a disengaged position disengaged from all of the at least one sockets of the race to allow rotation of the race and the shelf support structure about the axis of rotation.

6. The cart assembly of claim 5, wherein the swivel mechanism includes a spring operable to bias the retractable pin into the engaged position.

7. The cart assembly of claim 5, further comprising a pin actuator coupled to the retractable pin, and operable to move the retractable between from the engaged position into the disengaged position.

8. The cart assembly of claim 7, wherein the pin actuator includes a pedal rotatably mounted to the base, and a linkage system interconnecting the pedal and the retractable pin.

9. The cart assembly of claim 1, wherein the at least one shelf includes a thermoformed plastic tray.

10. The cart assembly of claim 1, wherein the at least one shelf includes three shelves arranged at three different levels of the shelf support structure.

11. The cart assembly of claim 10, wherein at least one of the three shelves is a moveable shelf configured to move into a folded position against the shelf support structure.

12. The cart assembly of claim 11, further comprising a hinge rod connecting the moveable shelf to the shelf support structure, wherein the hinge rod defines a hinge rod axis about which the moveable shelf rotates into the folded position.

13. The cart assembly of claim 12, wherein the moveable shelf includes a counterweight disposed between the shelf support structure and the hinge rod axis to counteract the weight of the shelf and reduce a lifting force required to move the shelf into the folded position against the shelf support structure.

14. The cart assembly of claim 11, further comprising a shelf latch operable to latch the moveable shelf to the shelf support structure when the moveable shelf is disposed in the folded position.

15. The cart assembly of claim 1, further comprising a plurality of guide sections disposed on a given one of the shelves and arranged with respect to each other to form a generally Y-shaped channel, wherein the generally Y-shaped channel is configured to receive a component.

16. The cart assembly of claim 1, further comprising a retaining bar and a pair of guide plates, wherein the guide plates each define a bar channel forming a curved path that receives and retains distal ends of the retaining bar to thereby retain the components during transport.

17. The cart assembly of claim 1, further comprising a brake attached to the base and selectively operable for movement into frictional engagement with a ground surface.

18. A cart assembly for transporting parts through a manufacturing facility, the cart assembly comprising:
a base having a plurality of wheels, and disposed on a plane defined by an X axis and a Y axis;
a shelf support structure orthogonally arranged with respect to the base, and extending from the base along a Z-axis;
at least one shelf supported by the shelf support structure; and
a swivel mechanism rotatably interconnecting the base and the shelf support structure for rotation about an axis of rotation, such that the shelf support structure and the at least one shelf are selectively rotatable with respect to the axis of rotation relative to the base, wherein the swivel mechanism includes:
a race that rotates with the shelf support structure about the axis of rotation;
wherein the race defines a plurality of sockets disposed annularly about the axis of rotation, on an outer circumference of the race;
a retractable pin connected to the base, wherein the retractable pin is moveable between an engaged position for interlocking engagement with one of the plurality of sockets to position the shelf support structure relative to the base and prevent rotation of the race and the shelf support structure about the axis of rotation relative to the base, and a disengaged position disengaged from all of the plurality of sockets of the race to allow rotation of the race and the shelf support structure about the axis of rotation;
a spring operable to bias the retractable pin into the engaged position; and
a pin actuator coupled to the retractable pin, and operable to move the retractable between from the engaged position into the disengaged position.

19. The cart assembly of claim 18, wherein the axis of rotation is parallel with the Z-axis.

20. The cart assembly of claim 18, wherein the pin actuator includes a pedal rotatably mounted to the base, and a linkage system interconnecting the pedal and the retractable pin.
